(19) United States
(12) Patent Application Publication
(10) Pub. No.: US 2016/0206984 A1
(43) Pub. Date: Jul. 21, 2016

(54) MELT-SPINNING PROCESS, MELT-SPUN NONWOVEN FIBROUS WEBS AND RELATED FILTRATION MEDIA

(71) Applicant: 3M INNOVATIVE PROPERTIES COMPANY, Saint Paul, MN (US)

(72) Inventors: Michael R. Berrigan, Oakdale, MN (US); Zackary J. Becker, St. Paul, MN (US); John D. Stelter, Osceola, WI (US); Francis E. Porbeni, Woodbury, MN (US); Liming Song, Woodbury, MN (US); Andrew R. Fox, Oakdale, MN (US)

(21) Appl. No.: 14/914,675

(22) PCT Filed: Sep. 2, 2014
(86) PCT No.: PCT/US14/53640

§ 371 Date: Feb. 26, 2016

Related U.S. Application Data
(60) Provisional application No. 61/873,110, filed on Sep. 3, 2013.

(51) Int. Cl. B01D 39/16; B01D 29/01; B01D 29/03; D04H 3/02; D04H 3/14

(52) U.S. Cl. CPC B01D 39/163; D04H 3/02; D04H 3/14; B01D 29/031; B01D 29/012

(57) ABSTRACT

High loft nonwoven webs including a population of substantially continuous mono-component melt-spun filaments, wherein the nonwoven web exhibits a Solidity of less than eight percent with a weight normalized cross direction (CD) tensile greater than 10 Newtons per 100 grams per square meter of web weight (10 N/100 gsm), and wherein the nonwoven web is substantially free of gap-formed fibers, crimped fibers, staple fibers, and bi-component fibers. High loft spun-bond nonwoven webs can be advantageously used in filtration articles. Methods of making high loft spun-bond nonwoven webs, and filtration articles including high loft spun-bond webs made according to the methods, are also disclosed.

### TECHNICAL FIELD

The present disclosure relates to a melt-spinning process, melt-spun nonwoven fibrous webs and more particularly spun-bond nonwoven fibrous webs, and related filtration media using such webs.

### BACKGROUND

Nonwoven webs have been used to produce a variety of absorbent articles that are useful, for example, as absorbent wipes for surface cleaning, as wound dressings, as gas and liquid absorbent or filtration media, and as barrier materials for sound absorption. For example, U.S. Pat. No. 6,740,137 discloses nonwoven webs and methods of making such webs for use in a collapsible pleated filter element. Although some methods of forming nonwoven fibrous webs are known, the art continually seeks new methods of forming nonwoven webs.

### SUMMARY

The present disclosure relates to a nonwoven web including a population of substantially continuous mono-component melt-spun filaments, wherein the nonwoven web exhibits a Solidity of less than eight percent with a weight normalized cross direction (CD) tensile greater than 10 Newtons per 100 grams per square meter of web weight (10 N/100 gsm), and wherein the nonwoven web is substantially free of gap-formed fibers, crimped fibers, staple fibers, and bi-component fibers. In some exemplary embodiments, the population of spun-bond filaments includes (co)polymeric filaments. In certain exemplary embodiments, the (co)polymeric filaments comprise polypropylene, polyethylene, polyester, polyethylene terephthalate, polybutylene terephthalate, polytrimethylene terephthalate, polyamide, polyurethane, polybutene, polylactic acid, polyvinyl alcohol, polyhydroxy alkonates (PHA), polyhydroxybutyrates (PHB), polyphenylene sulfide, polysulfone, liquid crystalline polymer, polyethylene-co-vinylacetate, polyacrylonitrile, cyclic polyolefin, polyoxymethylene, or polyolefinic thermoplastic elastomers. In some particular exemplary embodiments, the (co)polymeric filaments comprise polyolefin filaments.

In further exemplary embodiments of any of the foregoing, the population of melt-spun filaments exhibits a median Fiber Diameter of from 15 to 45 micrometers. In various exemplary embodiments of any of the foregoing, the population of melt-spun filaments is bonded together at a plurality of intersections between one or more of the filaments. In further exemplary embodiments of the foregoing, the population of melt-spun filaments forms a first layer of the nonwoven web, and a second layer of the nonwoven web includes staple fibers, air-laid fibers, melt-blown fibers, melt-spun filaments, electrospun fibers, wet-laid fibers, or a combination thereof. In some such exemplary embodiments, the second layer includes melt-spun filaments that differ from the population of melt-spun filaments comprising the first layer.

In additional exemplary embodiments of any of the foregoing, the second layer exhibits a Solidity greater than eight percent. In some exemplary embodiments of any of the foregoing, the nonwoven web exhibits a basis weight of from about 30 to about 120 grams per square meter (gsm). In further exemplary embodiments of any of the foregoing, the nonwoven web exhibits a thickness of at least 0.4 millimeters (mm).

The disclosure also relates to a filter including the nonwoven web as described herein. In some embodiments, a filter includes a plurality of oppositely-facing pleats. In certain such exemplary embodiments, the plurality of pleats is self-supporting. In some such exemplary embodiments, the plurality of pleats is not self-supporting and the filter further includes a mesh to support the plurality of pleats. In some particular such exemplary embodiments, the filter comprises a biodegradable material, a particulate material, a frame material, or a combination thereof.

The present disclosure also relates to a method of making a nonwoven fibrous web, including: forming a multiplicity of substantially continuous melt-spun filaments with a melt-spinning process, wherein the melt-spinning process includes a filament spinning speed of at least 3,000 meters per minute (m/min) and optionally, a filament extrusion rate of at least 0.8 grams per orifice per minute (gom); collecting a population of the melt-spun filaments on a collector surface; and bonding at least a portion of the melt-spun filaments together at a multiplicity of intersections between one or more of the filaments, optionally wherein the bonding includes autogeneous bonding.

In some such exemplary embodiments, the multiplicity of melt-spun filaments are mono-component filaments, further wherein the population of melt-spun filaments exhibits a Median Fiber Diameter of from 15 to 45 micrometers and the nonwoven web exhibits a Solidity of less than eight percent with a weight-normalized cross direction (CD) tensile greater than 10 Newtons per 100 grams per square meter of web weight (10 N/100 gsm), and additionally wherein the nonwoven web is substantially free of gap-formed fibers, crimped fibers, staple fibers, and bi-component fibers.

In some particular such exemplary embodiments, the method further includes producing a first layer of the nonwoven web, wherein the method is repeated to form a second layer of the nonwoven web over the first layer. In some such exemplary embodiments, the method further includes electrostatically charging at least a portion of the melt-spun filaments. In certain such exemplary methods, the filament spinning speed is no greater than 7,000 m/min. In some such methods, a quenched flow heater (e.g. a thru-air bonder) is used to bond the filaments.

Various exemplary embodiments of the present disclosure are further illustrated by the following listing of exemplary embodiments, which should not be construed to unduly limit the present disclosure:

### LISTING OF EXEMPLARY EMBODIMENTS

A. A nonwoven web comprising a population of substantially continuous mono-component melt-spun filaments, wherein the nonwoven web exhibits a Solidity of less than eight percent with a weight normalized cross direction (CD) tensile greater than 10 Newtons per 100 grams per square meter of web weight (10 N/100 gsm), and wherein the nonwoven web is substantially free of gap-formed fibers, crimped fibers, staple fibers, and bi-component fibers.
B. The nonwoven web of embodiment A, wherein the population of melt-spun filaments exhibits a Median Fiber Diameter of from 15 to 45 micrometers.
C. The nonwoven web of any preceding embodiment, wherein the population of melt-spun filaments is bonded together at a plurality of intersections between one or more of the filaments.
D. The nonwoven web of any preceding embodiment, wherein the population of melt-spun filaments comprises a (co)polymer selected from one of polypropylene, polyethylene, polybutene, polyethylene terephthalate, polybutylene terephthalate, polytrimethylene terephthalate, polyethylene napthalate, polyamide, polyurethane, polylactic acid, polyvinyl alcohol, polyphenylene sulfide, polysulfone, liquid crystalline polymer, polyethylene-co-vinylacetate, polyacrylonitrile, cyclic polyolefin, polyoxymethylene, or polyolefinic thermoplastic elastomers.
E. The nonwoven web of any preceding embodiment, wherein the population of melt-spun filaments forms a first layer of the nonwoven web, and a second layer of the nonwoven web comprises staple fibers, air-laid fibers, melt-blown fibers, melt-spun filaments, electrospun fibers, wet-laid fibers, or a combination thereof.
F. The nonwoven web of embodiment E, wherein the second layer comprises melt-spun filaments that differ from the population of melt-spun filaments comprising the first layer.
G. The nonwoven web of embodiments E or F, wherein the second layer exhibits a Solidity greater than eight percent.
H. The nonwoven web of any preceding embodiment, exhibiting a basis weight of from about 30 to about 120 grams per square meter (gsm).
I. The nonwoven web of any preceding embodiment, exhibiting a thickness of at least about 0.4 millimeters (mm)
J. A filter comprising the nonwoven web of any one of embodiments A-I.
K. The filter of embodiment J, having a plurality of oppositely-facing pleats.
L. The filter of embodiment K, wherein the plurality of pleats is self-supporting.
M. The pleated filter of embodiment K, wherein the plurality of pleats is not self-supporting, and further wherein the filter further comprises a mesh to support the pleats.
N. The filter of any one of embodiments J-M, wherein the filter further comprises a biodegradable material, a particulate material, a frame material, or a combination thereof.
O. A method of making a nonwoven web, comprising:
   a. forming a plurality of substantially continuous melt-spun filaments with a melt-spinning process, wherein the melt-spinning process comprises a filament spinning speed of at least 3,000 meters per minute (m/min) and optionally, a filament extrusion rate of at least 0.8 grams per orifice per minute (gom);
   b. collecting a population of the melt-spun filaments on a collector surface; and
   c. bonding at least a portion of the melt-spun filaments together at a plurality of intersections between one or more of the filaments, optionally wherein the bonding comprises autogeneous bonding.
P. The method of embodiment O, wherein the plurality of melt-spun filaments are mono-component filaments, further wherein the population of melt-spun filaments exhibits a Median Fiber Diameter of from 15 to 45 micrometers and the nonwoven web exhibits a Solidity of less than eight percent with a weight-normalized cross direction (CD) tensile greater than 10 Newtons per 100 grams per square meter of web weight (10 N/100 gsm), and additionally wherein the nonwoven web is substantially free of gap-formed fibers, crimped fibers, staple fibers, and bi-component fibers.
Q. The method of embodiment O or P, wherein (a)-(c) are performed to produce a first layer of the nonwoven web, and wherein (a)-(c) are repeated to form a second layer of the nonwoven web over the first layer.
R. The method of any one of embodiments O-Q, further comprising electrostatically charging at least a portion of the melt-spun filaments.
S. The method of any one of embodiments O-R, wherein the filament spinning speed is no greater than 7,000 m/min
T. The method of any one of embodiment O-S, wherein a quenched flow heater is used in (c) to bond the filaments.

Various aspects and advantages of embodiments of the presently disclosed invention have been summarized. The above Summary is not intended to describe each illustrated embodiment or every implementation of the presently disclosed invention. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying drawings, in which it is to be understood by one of ordinary skill in the art that the drawings illustrate certain exemplary embodiments only, and are not intended as limiting the broader aspects of the present disclosure.

FIG. 1 is a schematic overall diagram of an exemplary apparatus for forming a high loft spun-bond nonwoven web according to certain embodiments of the present disclosure.

FIG. 2 is an enlarged side view of an optional processing chamber for attenuating filaments useful in forming a high loft spun-bond nonwoven web according to certain embodiments of the present disclosure, with mounting means for the chamber not shown.

FIG. 3 is a perspective view of the apparatus of FIG. 1, showing an exemplary perforated patterned collector, useful for forming a high loft spun-bond nonwoven web according to an embodiment of the present disclosure.

FIG. 4 is a schematic enlarged and expanded view of an exemplary optional quenched-flow heating part of the apparatus shown in FIG. 3.

FIG. 5 is a perspective view of an exemplary pleated filtration media.

FIG. 6 is a perspective view, partially in section, of an exemplary pleated filter with a perimeter frame and a scrim attached to the pleat tips.

Repeated use of reference characters in the specification and drawings is intended to represent the same or analogous features or elements of the disclosure. While the above-identified drawings, which may not be drawn to scale, set forth various embodiments of the present disclosure, other embodiments are also contemplated, as noted in the Detailed Description.

### DETAILED DESCRIPTION

In the following detailed description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claimed embodiments, each numerical parameter should at least be construed in light of the number of reported significant digits and by applying ordinary rounding techniques. In addition, the use of numerical ranges with endpoints includes all numbers within that range (e.g. 1 to 5 includes 1, 1.5, 2, 2.75, 3, 3.80, 4, and 5) and any narrower range or single value within that range.

### GLOSSARY

Certain terms are used throughout the description and the claims that, while for the most part are well known, may require some explanation. It should be understood that, as used herein:

The terms “about,” “approximate,” or “approximately” with reference to a numerical value or a geometric shape means+/−five percent of the numerical value or the value of the internal angle between adjoining sides of a geometric shape having a commonly recognized number of sides, expressly including any narrower range within the +/−five percent of the numerical or angular value, as well as the exact numerical or angular value. For example, a temperature of “about” 100° C. refers to a temperature from 95° C. to 105° C., but also expressly includes any narrower range of temperature or even a single temperature within that range, including, for example, a temperature of exactly 100° C. Likewise, an “approximately square” geometric shape includes all four-sided geometric shapes exhibiting internal angles between adjoining sides of 85-95 degrees from the 90 degree internal angle between adjoining sides corresponding to a perfect square geometric shape.

The term “substantially” with reference to a property or characteristic means that the property or characteristic is exhibited to within 98% of that property or characteristic, but also expressly includes any narrow range within the two percent of the property or characteristic, as well as the exact value of the property or characteristic. For example, a substrate that is “substantially” transparent refers to a substrate that transmits 98-100% of incident light.

The terms “a”, “an”, and “the” include plural referents unless the content clearly dictates otherwise. Thus, for example, reference to a material containing “a compound” includes a mixture of two or more compounds.

The term “or” is generally employed in its sense including “and/or” unless the content clearly dictates otherwise.

The term “(co)polymer” means a relatively high molecular weight material having a molecular weight of at least about 10,000 g/mole (in some embodiments, in a range from 10,000 g/mole to 5,000,000 g/mole). The terms “(co)polymer” or “(co)polymers” includes homopolymers and copolymers, as well as homopolymers or copolymers that may be formed in a miscible blend, e.g., by co-extrusion or by reaction, including, e.g., transesterification. The term “(co)polymer” includes random, block and star (e.g. dendritic) (co)polymers.

The term “filament” is used in general to designate molten streams of thermoplastic material that are extruded from a set of orifices, and the term “fibers” is used in general to designate solidified filaments and webs comprised thereof. These designations are used for convenience of description only. In processes as described herein, there may be no firm dividing line between partially solidified filaments, and fibers which still comprise a slightly tacky and/or semi-molten surface.

The term “continuous” when used with respect to a filament or collection of filaments means filaments having an essentially infinite aspect ratio (viz., a ratio of length to size of e.g., at least about 10,000 or more).

The term “oriented” when used with respect to a filament means that at least portions of the polymer molecules within the filaments are permanently aligned with the longitudinal axis of the filaments, for example, by use of a drawing process or attenuator upon a stream of filaments exiting from a die.

The terms “nonwoven fibrous web” or “nonwoven web” mean a collection of filaments characterized by entanglement or point bonding of the filaments to form a sheet or mat.

The term “mono-component” when used with respect to a filament or collection of filaments means filaments having essentially the same composition across their cross-section; mono-component includes blends (viz., polymer alloys) or additive-containing materials, in which a continuous phase of uniform composition extends across the cross-section and over the length of the fiber.

The term “melt-spun” refers to fibers that are formed by extruding filaments out of a set of orifices and allowing the filaments to cool and solidify to form fibers, with the filaments passing through an air space (which may contain streams of moving air) to assist in cooling the filaments and passing through an attenuation (i.e., drawing) unit to at least partially draw the filaments. Melt-spinning can be distinguished from melt-blowing in that melt-blowing involves the extrusion of filaments into converging high velocity air streams introduced by way of air-blowing orifices located in close proximity to the extrusion orifices.

The term “bonding” when used with respect to a filament or collection of filaments means adhering together firmly; bonded filaments generally do not separate when a web is subjected to normal handling.

The term “spun-bonded” describes a web comprising a set of melt-spun fibers that are collected as a fibrous web and optionally subjected to one or more bonding operations.

The term “autogenous bonding” means bonding between filaments at an elevated temperature as obtained, for example, in an oven or with a quenched flow heater (e.g. a thru-air bonder) without application of solid contact pressure such as in point-bonding or calendering.

The term “directly collected fibers” describes fibers formed and collected as a web in essentially one operation, by extruding molten filaments from a set of orifices and collecting the at least partially solidified filaments as fibers on a collector surface without the filaments or fibers contacting a deflector or the like between the orifices and the collector surface.

The term “pleated” describes a web wherein at least portions of which have been folded to form a configuration comprising rows of generally parallel, oppositely oriented folds. As such, the pleating of a web as a whole is distinguished from the crimping of individual fibers.

The term “self-supporting” with respect to a monolayer matrix (e.g., a nonwoven fibrous web, and the like) describes that the matrix does not include a contiguous reinforcing layer of wire, mesh, or other stiffening material even if a pleated filter element containing such matrix may include tip stabilization (e.g., a planar wire face layer) or perimeter reinforcement (e.g., an edge adhesive or a filter frame) to strengthen selected portions of the filter element. Alternatively, or in addition, the term “self-supporting” describes a filter element that is deformation resistant without requiring stiffening layers, bi-component fibers, adhesive or other reinforcement in the filter media.

The term “crimped fibers” describes fibers that have undergone a crimping process. Crimping processes include mechanical crimping (e.g., of staple fibers). Crimping processes also include thermal activation processes in which bi-component fibers (e.g., conjugate fibers) are exposed to temperatures such that crimping occurs due to a disparity in the shrinkage among the components of the fiber. Crimping processes also include thermal activation processes in which geometrically asymmetric thermal treatment of fibers is performed so as to generate a solidification gradient in the fibers thus resulting in crimping. Such thermal activation processes or other crimping processes may occur before, during, or after the spun-bonding process. Crimped fibers may be identified as displaying repeating features (as manifested e.g. in a wavy, jagged, sinusoidal, and the like appearance of the fiber), by having a helical appearance (e.g., particularly in the case of crimped fibers obtained by thermal activation of bi-component fibers), and the like, and are recognizable by those of ordinary skill in the art. Examples of crimped fibers are described in U.S. Pat. No. 4,118,531 to Hauser, and U.S. Pat. No. 5,597,645 to Pike, et al.; as well as Canadian Patent No. 2,612,854 to Sommer, et al.

The term “gap-formed fibers” describes fibers collected in a gap (e.g., a converging gap) between two spaced-apart surfaces (e.g., in a nip, slot, and the like). Gap-formed fibers may be identified as displaying, when a web is viewed in cross section, a generally repeating pattern of U-shaped or C-shaped fibers, and/or a generally repeating pattern of waves, folds, loops, ridges, or the like, and as having a significant number of fibers of the web being oriented generally along the shortest dimension (the thickness direction) of the web. In this context, gap-formed fibers includes fibers as may be preliminarily collected on a single (e.g. generally flat collecting surface), and then passed through a converging gap, nip, and the like, that achieves the aforementioned pattern of waves, folds, or the like. Examples of gap-formed fibers are described in U.S. Pat. No. 6,588,080 to Neely, et al., U.S. Pat. No. 6,867,156 to White, et al., and U.S. Pat. No. 7,476,632 to Olson, et al.

The term “Solidity” describes a dimensionless fraction (usually reported in percent) that represents the proportion of the total volume of a nonwoven web that is occupied by the solid (e.g. polymeric filament) material. Further explanation and methods for obtaining Solidity are found in the Examples section. Loft is 100% minus Solidity and represents the proportion of the total volume of the web that is unoccupied by solid material.

The term “Effective Fiber Diameter” when used with respect to a collection of fibers means the value according to the method set forth in Davies, C. N., “The Separation of Airborne Dust and Particles,” Institution of Mechanical Engineers, London Proceedings 1B, 1952 for a web of fibers of any cross-sectional shape be it circular or non-circular.

The term “Nominal Melting Point” for a polymer or a polymeric filament corresponds to the approximate temperature at which the peak maximum of a second-heat or total-heat flow differential scanning calorimetry (DSC) plot occurs in the melting region of the polymer or filament if there is only one maximum in the melting region; and, if there is more than one maximum indicating more than one melting point (e.g., because of the presence of two distinct crystalline phases), as the temperature at which the highest-amplitude melting peak occurs.

The term “charged” when used with respect to a collection of filaments describes filaments that exhibit at least a 50 percent loss in Quality Factor (QF) after being exposed to a 20 Gray absorbed dose of 1 millimeter (mm) beryllium-filtered 80 peak kilo-voltage (KVp) X-rays when evaluated for percent dioctyl phthalate (% DOP) penetration at a face velocity of 7 centimeters per second (cm/sec).

The term “porous” means air-permeable.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

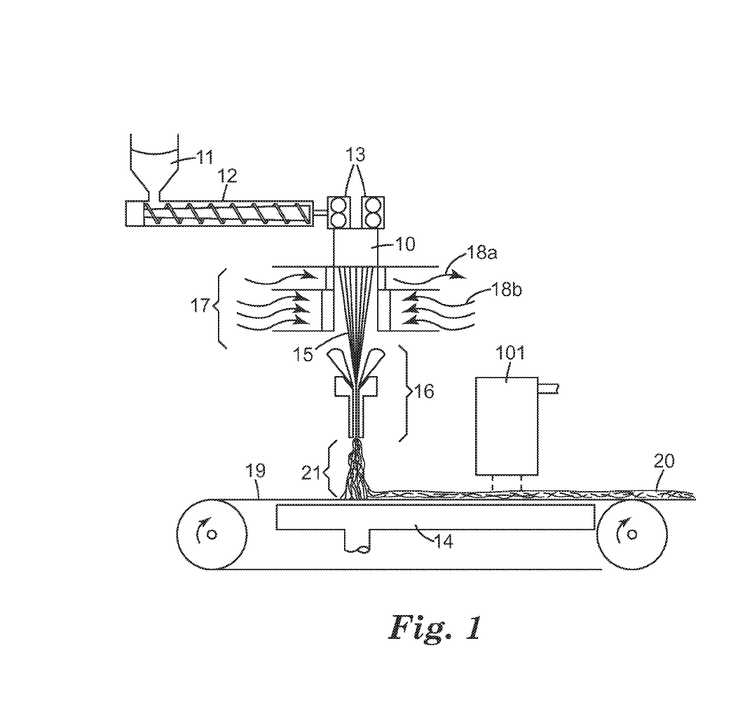

Referring now to FIG. 1, an apparatus which may be used to form spun-bond nonwoven webs as disclosed herein is shown. In a method of using such an apparatus, polymeric fiber-forming material is introduced into hopper 11, melted in an extruder 12, and pumped into extrusion head 10 via pump 13. Solid polymeric material in pellet or other particulate form can, for example, be used and melted to a liquid, pumpable state.

Extrusion head 10 may be a conventional spinnerette or spin pack, generally including multiple orifices arranged in a regular pattern (e.g., straightline rows). Filaments 15 of filament-forming liquid are extruded from the extrusion head 10 and may be conveyed through air-filled space 17 to attenuator 16. Air may be supplied to attenuator 16 from one or both sides of attenuator 16. Embodiments of the present disclosure can allow for high speed operation of the web forming apparatus. For example, the process can be run at various spinning speeds. In some embodiments, the spinning speed can be achieved at or above 3,000 meters per minute (m/min) In certain embodiments, the spinning speed is in the range of 3,000 m/min and 7,000 m/min Spinning speeds that are at or above 3,000 m/min can produce coarse extruded filaments that are stronger compared to extruded filaments that are produced at lower spinning speeds.

The extrusion head 10 can be set to incorporate various extrusion rates of the filament-forming liquid. For example, in certain embodiments the extrusion rate is set at a rate of at least 0.8 grams per orifice per minute (gom) (e.g., grams per hole per minute (ghm)). In other embodiments, the extrusion rate is set to a range between approximately 0.8 gom to 2.0 gom.

By setting the extrusion rate of the extrusion head 10 and/or achieving a spinning speed as described herein, the extruded filaments 15 can have coarser properties compared to alternative spinning speeds and/or extrusion rates, among other benefits. The coarse properties of the extruded filaments 15 include a diameter that is greater than a diameter of extruded filaments formed using lower extrusion rate settings. In some embodiments, the extruded filaments 15 have a diameter that is greater than 15 micrometers. In particular embodiments, the extruded filaments 15 have a diameter that is in a range of 15-45 micrometers.

The distance the extruded filaments 15 travel through air space 17 before reaching the attenuator 16 can vary, as can the conditions to which they are exposed. Quenching streams of air 18 may be directed toward extruded filaments 15 to reduce the temperature of, and/or to partially solidify, the extruded filaments 15. Although the term “air” is used for convenience herein, it is understood that other gases and/or gas mixtures may be used in the quenching and drawing processes disclosed herein. One or more streams of air may be used; e.g., a first air stream 18a blown transversely to the filament stream, which may serve primarily to remove undesired gaseous materials or fumes released during extrusion among other functions, and a second quenching air stream(s) 18b that may, in some embodiments, serve primarily to achieve temperature reduction. The flow rate of the quenching air stream(s) may be manipulated to advantage, as disclosed herein, to assist in achieving webs with the unique properties disclosed herein.

Filaments 15 may pass through attenuator 16 (discussed in more detail below) and then be deposited onto a generally flat (by which is meant comprising a radius of curvature of more than about six inches) collector surface 19 where they are collected as a mass of filaments 20. Collecting filaments and/or fibers on generally flat collector surface 19 should be distinguished from, for example, collecting filaments and/or fibers in a gap between spaced-apart surfaces. Collector surface 19 may comprise a single, continuous collector surface such as provided by a continuous belt or a drum or roll with a radius of at least six inches. Collector 19 may be generally porous and gas-withdrawal (vacuum) device 14 can be positioned below the collector to assist deposition of fibers onto the collector (porosity of the collector does not change the fact that the collector is generally flat as defined above). The distance 21 between the attenuator exit and the collector may be varied to obtain different effects. Also, prior to collection, extruded filaments may be subjected to a number of additional processing steps not illustrated in FIG. 1 (e.g., further drawing, spraying, and the like)

After collection, the collected mass 20 (web) of spun-bonded filaments may be subjected to one or more bonding operations. For example, the spun-bonded filaments can be subjected to bonding operations to enhance the integrity and/or handleability of the web. In certain embodiments, such bonding may comprise autogeneous bonding (e.g., as achieved by use of an oven and/or a stream of controlled-temperature air) without the application of solid contact pressure onto the web. Such bonding may be performed by the directing of heated air onto the web, e.g. by the use of controlled-heating device 101. Such devices are discussed in further detail in U.S. Patent Application Publication No. 2008/0038976 to Berrigan et al., which is incorporated by reference herein for this purpose.

In addition to, or in place of, such bonding, other well known bonding methods such as the use of calendering rolls, may be employed. Spun-bonded web 20 may be conveyed to one or more other apparatuses such as embossing stations, laminators, cutters and the like, wound into a storage roll, and the like. In some embodiments, the bonding operation includes a quenched-flow heater (e.g. a thru-air bonder) that does not increase the Solidity of the collected mass 20.

The loft of webs utilizing the coarser filaments will be characterized herein in terms of Solidity (as defined herein and as measured by methods reported herein). As disclosed herein, webs of Solidity from about 4.0% to less than 8.0% (i.e., of loft of from about 96.0% to greater than 92.0%) can be produced. In various embodiments, webs as disclosed herein comprise a Solidity of at most about 7.5%, at most about 7.0%, or at most about 6.5%. In further embodiments, webs as disclosed herein comprise a Solidity of at least about 5.0%, at least about 5.5%, or at least about 6.0%.

In some embodiments the collected mass 20 can represent a first layer of nonwoven web. In various embodiments, additional layers of nonwoven web material can be deposited on the first layer of nonwoven web (e.g., collected mass 20). For example, in certain embodiments, a second layer of nonwoven web comprises the same and/or similar web as the first layer of nonwoven web. In certain embodiments, the first layer and the second layer of nonwoven web each comprise a web formed utilizing the coarser filaments as described herein (e.g., each layer exhibiting a Solidity of less than eight percent with a normalized CD tensile greater than 10 N and wherein each nonwoven web is substantially free of gap-formed fibers, crimped fibers, staple fibers, and bi-component fibers).

In certain embodiments, an additional layer of nonwoven web material (e.g., second layer of nonwoven web material, and the like) comprises a different web compared to the first layer of nonwoven web material. For example, in specific embodiments, the second layer of nonwoven web material comprises staple fibers, air-laid fibers, melt-blown fibers, melt-spun filaments, electrospun fibers, wet-laid fibers, or a combination thereof. In specific embodiments, the first layer of nonwoven web material and one or more of the additional layers of nonwoven web material are bonded together to form a single nonwoven web. For example, the first layer of nonwoven web material and a second layer of nonwoven web material can be bonded utilizing a blow process or an adhesive layer between the first layer and the second layer, among other methods for bonding a first layer of nonwoven web material to an additional layer of nonwoven web material.

In some embodiments, an additional layer of nonwoven web material comprises melt-spun filaments that are different from the population of melt-spun filaments that comprise the first layer of nonwoven web material. In specific embodiments, the additional layer of nonwoven web material comprises filaments that have a diameter that is less than 15 micrometers and the first layer of nonwoven web comprises filaments that have a diameter that is in the range of 15 micrometers to 45 micrometers. In certain embodiments one or more of the additional layers of nonwoven web exhibits a Solidity that is greater than 8 percent while the first layer of nonwoven web exhibits a Solidity that is less than 8 percent.

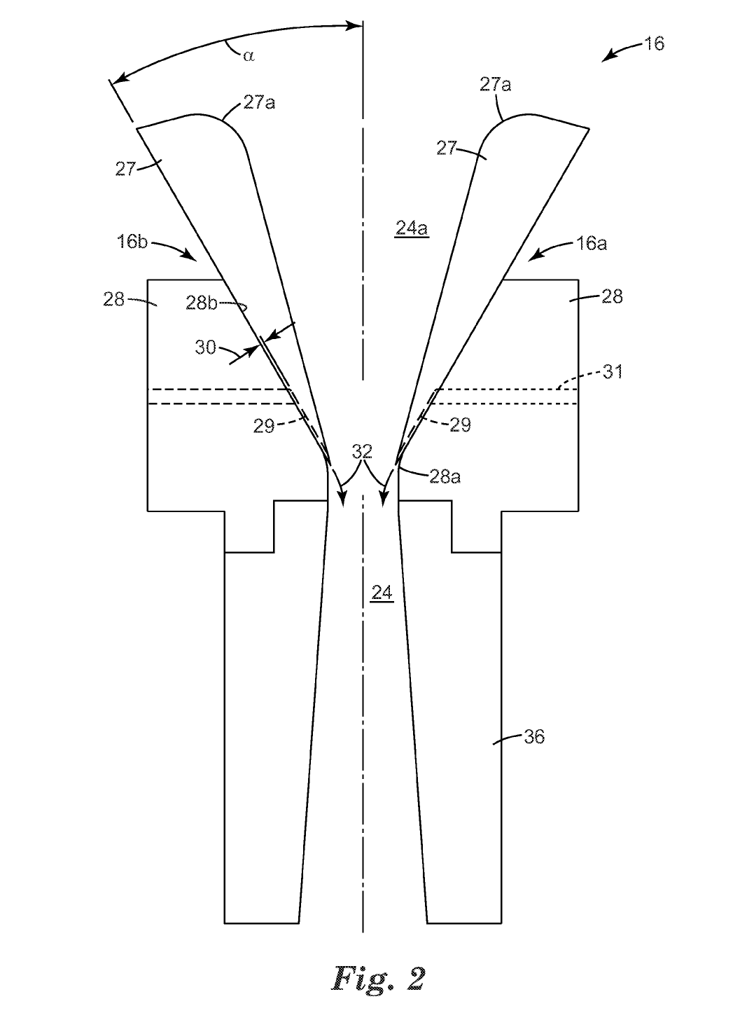

FIG. 2 is an enlarged side view of an attenuator 16 through which filaments may pass. Attenuator 16 may serve to at least partially draw filaments and may serve to cool and/or quench filaments additionally (e.g., in addition to any cooling and/or quenching of filaments which may have already occurred in passing through the distance between extrusion head 10 and attenuator 16). Such at least partial drawing may serve to achieve at least partial orientation of at least a portion of each filament, with commensurate improvement in strength of the solidified fibers produced therefrom, as is well known by those of skill in the art.

Attenuator 16, in some embodiments, may comprise two halves or sides 16a and 16b separated so as to define between them an attenuation chamber 24. Although existing as two halves or sides (in this particular instance), the attenuator 16 functions as one unitary device, but will be first discussed in its combined form. Attenuator 16 includes slanted entry walls 27, which define an entrance space or throat 24a of the attenuation chamber 24. The entry walls 27 preferably are curved at the entry edge or surface 27a to smooth the entry of air streams carrying the extruded filaments 15. The walls 27 are attached to a main body portion 28, and may be provided with a recessed area 29 to establish an air gap 30 between the body portion 28 and wall 27.

Air may be introduced into the gaps 30 through conduits 31. The attenuator body 28 may be curved at 28a to smooth the passage of air from the air knife 32 into chamber 24. The angle α of the surface 28b of the attenuator body can be selected to determine the desired angle at which the air knife impacts a stream of filaments passing through the attenuator.

Attenuation chamber 24 may have a uniform gap width or the gap width may vary along the length of the attenuator chamber. The walls defining at least a portion of the longitudinal length of the attenuation chamber 24 may take the form of plates 36 that are separate from, and attached to, the main body portion 28.

In some embodiments, certain portions of attenuator 16 (e.g., sides 16a and 16b) may be able to move toward one another and/or away from one another (e.g., in response to a perturbation of the system). Such ability may be advantageous in some circumstances.

Further details of attenuator 16 and possible variations thereof are found in U.S. Patent Application Publication No. 2008/0038976 to Berrigan et al.; and in U.S. Pat. Nos. 6,607,624; 6,660,218; 6,824,372; and 6,916,752; each of which is incorporated herein by reference in their entirety for this purpose.

Certain high loft webs as heretofore reported by other workers in the field have relied on the presence of crimped fibers (as previously defined herein) to achieve high loft. Webs as described herein do not need to contain crimped fibers in order to achieve high loft. Thus, in some embodiments, webs as disclosed herein are substantially free of crimped fibers, which in this context means that less than one of every ten fibers of the web is a crimped fiber as defined herein. In further embodiments, less than one of every twenty fibers of the web is a crimped fiber as defined herein. Those of ordinary skill in the art will of course readily appreciate the difference between such nonlinear (e.g., curved) fibers or portions thereof, as may occur in the course of forming any spun-bonded web, and crimped fibers as defined herein. In particular embodiments, webs as described herein are substantially free of crimped staple fibers.

Often, high loft webs in the art rely on the use of so-called bi-component fibers which, upon particular thermal exposures (e.g., thermal activation), may undergo crimping (e.g., by virtue of the two components of the fiber being present in a side-by-side or eccentric sheath-core configuration and having different shrinkage characteristics, as is well known in the art).

Webs as disclosed herein do not need to contain bi-component fibers in order to achieve high loft. Thus, in some embodiments, webs as disclosed herein are entirely free of or at least substantially free of bi-component fibers. In some exemplary embodiments, less than one of every ten fibers of the web is made from a bi-component resin and with the balance of the fibers comprising mono-component fibers. In further exemplary embodiments, less than one of every twenty, less than one in every hundred, less than one in every thousand, or even less than one of every ten thousand fibers of the web is a bi-component fiber as defined herein.

In certain specific embodiments, webs as disclosed herein comprise only mono-component filaments, or at least substantially all mono-component filaments. Such mono-component webs of course do not preclude the presence of additives, processing aids, and the like, which may be present in the web (e.g., as particulate additives interspersed in the web, or as melt additives present within the material of individual filaments and/or fibers).

In minimizing the amount of bi-component fibers present, webs as disclosed herein may be advantageous in at least certain embodiments. For example, webs as disclosed herein may be comprised of mono-component filaments that are comprised substantially of polypropylene, which may be very amenable to being charged (e.g., electrostatically charged, if desired for filtration applications). Bi-component fibers which comprise an appreciable amount of e.g. polyethylene may not be as able to be charged due to the lesser ability of polyethylene to accept and retain an electrical charge. Webs comprised primarily of mono-component filaments as disclosed herein may have additional advantages over bi-component fibers in that high loft may be achieved without the necessity of a thermal activation step.

Certain high loft webs as heretofore reported by other workers in the field have relied on the presence of gap-formed fibers as defined herein. Webs of this type may comprise a significant number of fiber portions which are oriented in the z-direction (thickness direction) of the web. Such fibers may, when the web is viewed in cross section, exhibit e.g. loops, waves, ridges, peaks, folds, U-shapes or C-shapes (with the closed end of the U or C being generally positioned closer to an interior portion of the web and the arms of the U or C being positioned further from an interior portion of the web). The z-axis terminii of such fibers may be fused into the surfaces of the web.

Webs as disclosed herein do not need to contain gap-formed fibers in order to achieve high loft. Thus, in some exemplary embodiments, webs as disclosed herein are entirely free of or at least substantially free of gap-formed fibers, which as defined herein means that less than one of every twenty fibers of the web is a gap-formed fiber. In further exemplary embodiments, less than one of every twenty, less than one in every hundred, less than one in every thousand, or even less than one of every ten thousand fibers of the web is a gap-formed fiber as defined herein. Those of ordinary skill in the art will readily appreciate that in the formation of any spun-bonded web, some small number of fibers may form structures resembling those exhibited by gap-formed fibers. Those of ordinary skill in the art will further appreciate that such occurrences can easily be distinguished from a web made of gap-formed fibers.

In particular embodiments, webs as disclosed herein are substantially free of repeating patterns of C-shaped fibers, U-shaped fibers, and the like, and are substantially free of repeating patterns folds, loops, ridges, peaks, and the like. In further embodiments, webs as disclosed herein do not comprise a plurality of fibers in which the z-axis termini of the fibers are fused into the surfaces of the web.

In producing high loft webs via the use of a single, relatively conventional, generally flat collecting surface (e.g., collector surface 19 as referenced in FIG. 1), the processes disclosed herein advantageously avoid the complex arrangements of spaced-apart collecting surfaces that are typically required in order to provide gap-formed fibers.

Webs as disclosed herein have, in some exemplary embodiments, been found to exhibit unique characteristics which have not been reported heretofore. Specifically, the webs are characterized by having a Solidity of less than 8 percent with a weight normalized cross direction (CD) tensile that is greater than 10 Newtons per 100 grams per square meter of web weight (10 N/100 gsm). As described herein, the webs as disclosed herein exhibit these characteristics while being substantially free of gap-formed fibers, crimped fibers, staple fibers, and bi-component fibers. The weight normalized CD tensile is represented as a measured CD tensile over a basis weight reported in grams per square meter (gsm) and normalized by multiplying the value by 100. That is, the webs as disclosed herein exhibit a relatively high loft with a Solidity of less than 8 percent and a relatively high CD tensile strength and relatively high stiffness compared to other high loft nonwoven webs.

Those of ordinary skill in the art will thus appreciate that the methods disclosed herein allow melt-spun fibers to be produced under conditions that allow the fibers to be adequately drawn while allowing the fibers to unexpectedly form webs with advantageously high loft, high CD tensile strength, and high stiffness.

In producing high loft webs as disclosed herein, the method of collection of the fibers may also be manipulated to advantage. For instance, the amount of vacuum applied to the fiber collection surface (e.g., by gas-withdrawal device 14 as referenced in FIG. 1) may be held to a minimum, in order to preserve the highest loft. Webs as disclosed herein have proven to be capable of retaining high loft even with the use of a relatively large amount of vacuum.

Likewise, any subsequent bonding method (e.g., bonding method often used to enhance the integrity and physical strength of a web) may be manipulated to advantage. Thus, in the use of a controlled-heating device 101 of FIG. 1, the flowrate of any heated air supplied by device 101, and/or the amount of any vacuum applied in such process (e.g., by way of gas-withdrawal device 14) may be minimized Webs as disclosed herein have proven capable of retaining high loft even with the use of high bonding air velocity and/or high bonding air temperatures. Or, in bonding by calendering, the amount of force, and/or the actual area of calendering, may be held to a minimum (e.g., point-bonding may be used).

With particular regard to calendering, if such calendering is performed so that it significantly densifies the web areas that receive calendering force, and such that a relatively large area of the web is so calendered, the densified areas may alter certain measured properties of the web (e.g., the Effective Fiber Diameter) from that inherently achieved by the web prior to being calendered (and from that exhibited by the areas of the web that did not receive calendering force). Thus, in the particular case of webs which have been so calendered, it may be necessary to test uncalendered areas of a web, and/or to test the web in its precalendered condition, to determine whether the web falls within the parameters disclosed herein.

In various embodiments, basis weights of webs as disclosed herein may range e.g. from 30-120 grams per square meter (gsm). In some embodiments, webs as described herein may have a thickness that is at least about 0.4 millimeters (mm). In various embodiments, webs as disclosed herein may range from about 0.5 mm in thickness to about 3.0 mm in thickness.

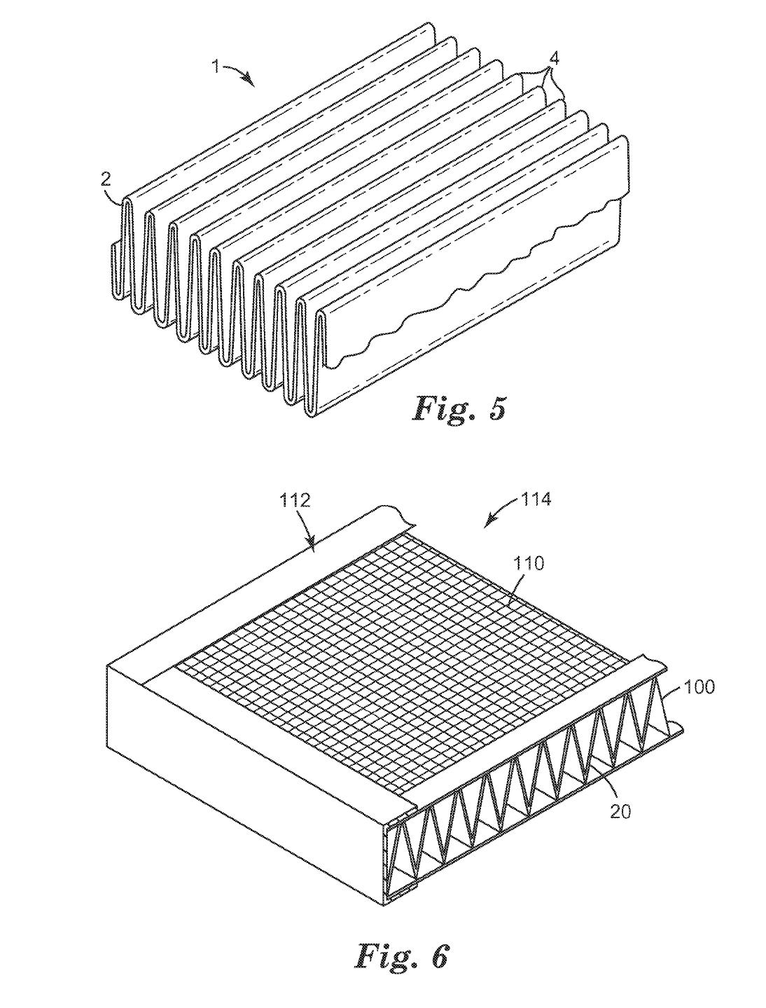

In some embodiments, webs as disclosed herein are self-supporting, meaning that they comprise sufficient integrity to be handleable using normal processes and equipment (e.g., can be wound up into a roll, pleated, assembled into a filtration device as shown in FIG. 5, and the like). As mentioned herein, bonding processes (e.g., autogeneous bonding via a controlled-heating apparatus, point-bonding, quenched-air heating bonding (e.g. thru-air bonding), and the like) may be used to enhance this self-supporting property. Autogenous bonding may be achieved using methods and apparatus described in U.S. Pat. Nos. 6,916,752 and 7,695,660; the entire disclosure of each reference being incorporated herein by reference in its entirety.

Furthermore, as described in more detail with reference to FIG. 5, the webs described herein that are self-supporting can be pleated to include a plurality of oppositely-facing pleats, as illustrated in FIG. 5 and discussed further below.

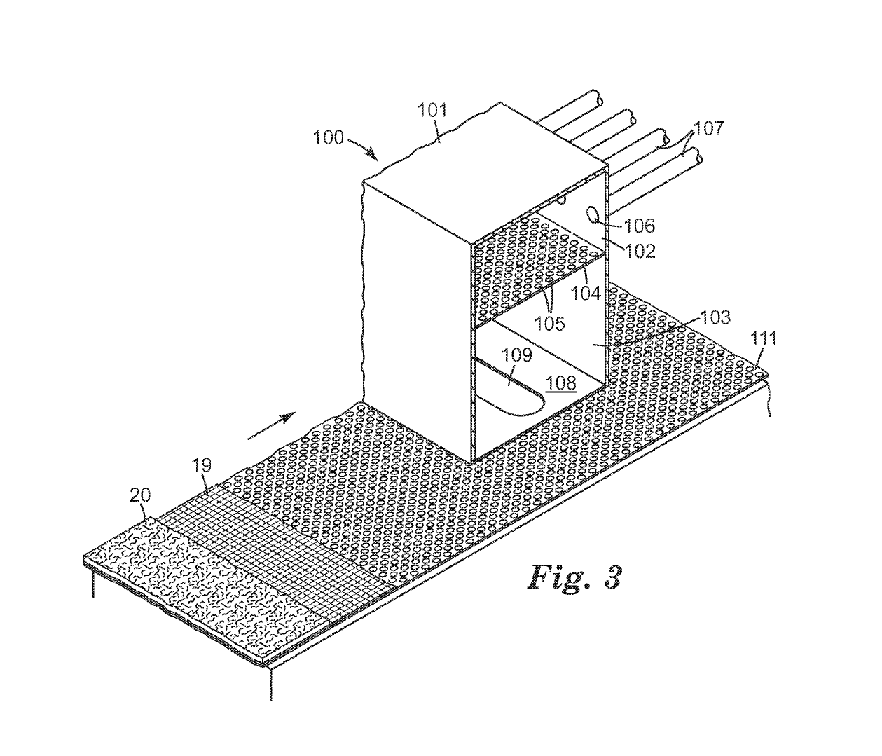

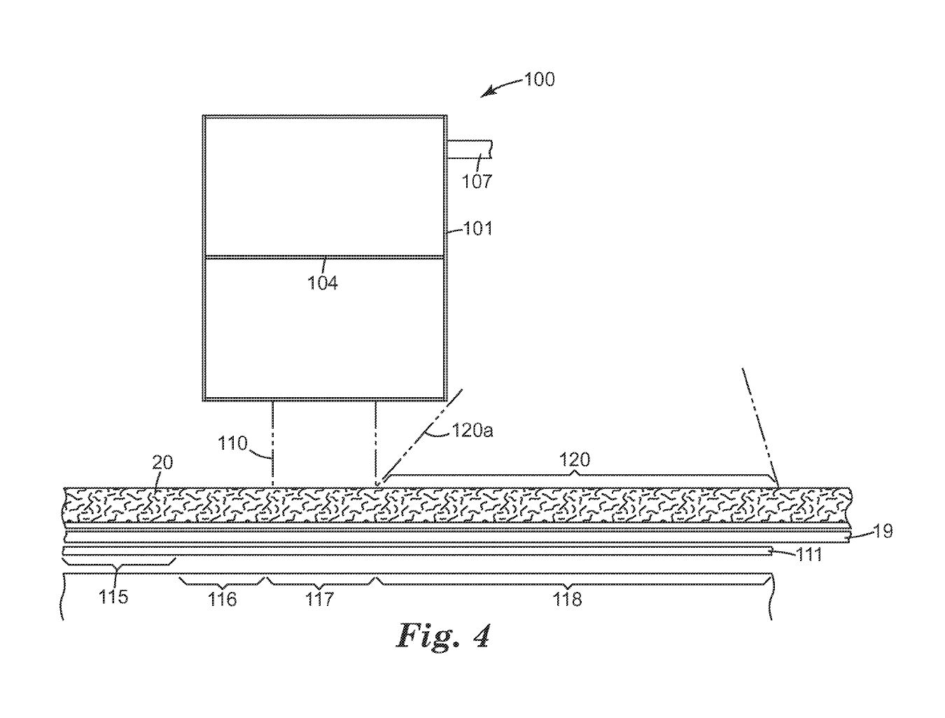

Turning now to FIGS. 3 and 4, a quenched flow heater, or more simply a quenched heater (e.g. a thru-air bonder) is shown which may be useful in practicing exemplary embodiments of the disclosure. Suitable quenched flow heaters are described in U.S. Pat. Nos. 7,807,591; 7,947,142; and 8,506,669; the entire disclosure of each reference being incorporated herein by reference in its entirety. In using quench flow heater, the collected mass 20 is first passed under a controlled-heating device 100 mounted above the collector 19. The heating device 100 comprises a housing 101 that is divided into an upper plenum 102 and a lower plenum 103. The upper and lower plenums are separated by a plate 104 perforated with a series of holes 105 that are typically uniform in size and spacing.

A gas, typically air, is fed into the upper plenum 102 through openings 106 from conduits 107, and the plate 104 functions as a flow-distribution means to cause air fed into the upper plenum to be rather uniformly distributed when passed through the plate into the lower plenum 103. Other useful flow-distribution means include fins, baffles, manifolds, air dams, screens or sintered plates, i.e., devices that even the distribution of air.

In the illustrative heating device 100 the bottom wall 108 of the lower plenum 103 is formed with an elongated slot 109 through which an elongated or knife-like stream 110 of heated air from the lower plenum is blown onto the collected mass 20 traveling on the collector 19 below the heating device 100 (the collected mass 20 and collector 19 are shown partly broken away in FIG. 3). The gas-withdrawal device 14 preferably extends sufficiently to lie under the slot 109 of the heating device 100 (as well as extending downweb a distance 118 beyond the heated stream 110 and through an area marked 120, as will be discussed below). Heated air in the plenum is thus under an internal pressure within the plenum 103, and at the slot 109 it is further under the exhaust vacuum of the gas-withdrawal device 14. To further control the exhaust force a perforated plate 111 may be positioned under the collector 19 to impose a kind of back pressure or flow-restriction means that contributes to spreading of the stream 110 of heated air in a desired uniformity over the width or heated area of the collected mass 20 and be inhibited in streaming through possible lower-density portions of the collected mass. Other useful flow-restriction means include screens or sintered plates.

The number, size and density of openings in the plate 111 may be varied in different areas to achieve desired control. Large amounts of air pass through the filament-forming apparatus and must be disposed of as the filaments reach the collector in the region 115. Sufficient air passes through the web and collector in the region 116 to hold the web in place under the various streams of processing air. Sufficient openness is needed in the plate under the heat-treating region 117 and quenching region 118 to allow treating air to pass through the web, while sufficient resistance remains to assure that the air is more evenly distributed.

The amount and temperature of heated air passed through the collected mass 20 is chosen to lead to an appropriate modification of the morphology of the filaments. Particularly, the amount and temperature are chosen so that the filaments are heated to a) cause melting/softening of significant molecular portions within a cross-section of the fiber (e.g., the amorphous-characterized phase of the fiber), but b) will not cause complete melting of another significant phase (e.g., the crystallite-characterized phase).

We use the term “melting/softening” because amorphous polymeric material typically softens rather than melts, while crystalline material, which may be present to some degree in the amorphous-characterized phase, typically melts. This can also be stated, without reference to phases, simply as heating to cause melting of lower-order crystallites within the filament. The filaments as a whole remain unmelted (e.g., filaments generally retain the same filament shape and dimensions as they had before treatment). Substantial portions of the crystallite-characterized phase are understood to retain their pre-existing crystal structure after the heat treatment. Crystal structure may have been added to the existing crystal structure, or in the case of highly ordered filaments crystal structure may have been removed to create distinguishable amorphous-characterized and crystallite-characterized phases.

To achieve the intended filament morphology change throughout the collected mass 20, the temperature-time conditions should be controlled over the whole heated area of the mass. We have obtained best results when the temperature of the stream 110 of heated air passing through the web is within a range of 5 degrees Celsius (° C.), and preferably within 2 or even 1° C., across the width of the mass being treated (the temperature of the heated air is often measured for convenient control of the operation at the entry point for the heated air into the housing 101, but it also can be measured adjacent the collected web with thermocouples). In addition, the heating apparatus is operated to maintain a steady temperature in the stream over time (e.g., by rapidly cycling the heater on and off to avoid over-heating or under-heating).

To further control heating and to complete formation of the desired morphology of the filaments of the collected mass 20, the mass is subjected to quenching immediately after the application of the stream 110 of heated air. Such a quenching can generally be obtained by drawing ambient air over and through the collected mass 20 as the mass leaves the controlled hot air stream 110.

Numeral 120 in FIG. 4 represents an area in which ambient air is drawn through the web by the gas-withdrawal device through the web. The gas-withdrawal device 14 extends along the collector for a distance 118 beyond the heating device 100 to assure thorough cooling and quenching of the whole mass 20 in the area 120. Air can be drawn under the base of the housing 101, e.g., in the area 120a marked on FIG. 4 of the drawing, so that it reaches the web directly after the web leaves the hot air stream 110.

A desired result of the quenching is to rapidly remove heat from the web and the filaments and thereby limit the extent and nature of crystallization or molecular ordering that will subsequently occur in the filaments. Generally the disclosed heating and quenching operation is performed while a web is moved through the operation on a conveyor, and quenching is performed before the web is wound into a storage roll at the end of the operation. The times of treatment depend on the speed at which a web is moved through an operation, but generally the total heating and quenching operation is performed in a minute or less, and preferably in less than 15 seconds.

By rapid quenching from the molten/softened state to a solidified state, the amorphous-characterized phase is understood to be frozen into a more purified crystalline form, with reduced molecular material that can interfere with softening, or repeatable softening, of the filaments. Desirably the mass is cooled by a gas at a temperature at least 50° C. less than the Nominal Melting Point; also the quenching gas or other fluid is desirably applied for a time on the order of at least one second. In any event the quenching gas or other fluid has sufficient heat capacity to rapidly solidify the filaments. Other fluids that may be used include water sprayed onto the filaments (e.g., heated water or steam to heat the filaments, and relatively cold water to quench the filaments).

Success in achieving the desired heat treatment and morphology of the amorphous-characterized phase often can be confirmed with DSC testing of representative filaments from a treated web. In addition, treatment conditions can be adjusted according to information learned from the DSC testing. Desirably the application of heated air and quenching are controlled so as to provide a web whose properties facilitate formation of an appropriate pleated matrix. If inadequate heating is employed the web may be difficult to pleat. If excessive heating or insufficient quenching are employed, the web may melt or become embrittled and also may not take adequate charge.

The disclosed nonwoven webs may have a random filament arrangement and generally isotropic in-plane physical properties (e.g., tensile strength), or if desired may have an aligned fiber construction (e.g., one in which the fibers are aligned in the machine direction as described in Shah et al. U.S. Pat. No. 6,858,297) and anisotropic in-plane physical properties.

A variety of (co)polymeric filament-forming materials may be used in the disclosed process. The (co)polymer may be essentially any thermoplastic filament-forming material capable of providing a nonwoven web. Suitable (co)polymers which may be used in forming filaments include polypropylene, polyethylene, polyester, polyethylene terephthalate, polybutylene terephthalate, polytrimethylene terephthalate, polyamide, polyurethane, polybutene, polylactic acid, polyvinyl alcohol, polyhydroxy alkonates (PHA), polyhydroxybutyrates (PHB), polyphenylene sulfide, polysulfone, liquid crystalline polymer, polyethylene-co-vinylacetate, polyacrylonitrile, cyclic polyolefin, polyoxymethylene, or polyolefinic thermoplastic elastomers.

For webs that will be charged the (co)polymer may be essentially any thermoplastic filament-forming material which will maintain satisfactory electret properties or charge separation. Preferred (co)polymeric filament- or fiber-forming materials for chargeable webs are non-conductive resins having a volume resistivity of 10¹⁴ ohm-centimeters or greater at room temperature (22° C.).

Preferably, the volume resistivity is about 10¹⁶ ohm-centimeters or greater. Resistivity of the (co)polymeric filament-forming material may be measured according to standardized test ASTM D 257-93. Polymeric filament-forming materials for use in chargeable webs also preferably are substantially free from components such as antistatic agents that could significantly increase electrical conductivity or otherwise interfere with the filament's ability to accept and hold electrostatic charges. Some non-limiting examples of (co)polymers which may be used advantageously in chargeable webs include thermoplastic (co)polymers containing polyolefins such as polyethylene, polypropylene, polybutylene, poly(4-methyl-1-pentene) and cyclic olefin copolymers.

Other (co)polymers which may be used but which may be difficult to charge or which may lose charge rapidly include polycarbonates, block copolymers such as styrene-butadiene-styrene and styrene-isoprene-styrene block copolymers, polyesters such as polyethylene terephthalate, polyamides, polyurethanes, and other polymers that will be familiar to those skilled in the art. The filaments preferably are prepared from poly-4-methyl-1 pentene or polypropylene. Most preferably, the filaments are prepared from polypropylene homopolymer because of its ability to retain electric charge, particularly in moist environments.

Electric charge can be imparted to the disclosed nonwoven webs in a variety of ways. This may be carried out, for example, by contacting the web with water as disclosed in U.S. Pat. No. 5,496,507 to Angadjivand et al., corona-treating as disclosed in U.S. Pat. No. 4,588,537 to Klasse et al., hydrocharging as disclosed, for example, in U.S. Pat. No. 5,908,598 to Rousseau et al., plasma treating as disclosed in U.S. Pat. No. 6,562,112 B2 to Jones et al. and U.S. Patent Application Publication No. US2003/0134515 A1 to David et al., or combinations thereof. Electric charge-enhancing additives may also be incorporated into the webs. This may be carried out, for example, by incorporating materials such as those taught in U.S. Patent Application Publication No. US2012/0017910 A1 to Li et al.

FIG. 5 shows in perspective view a pleated filter 1 made from the disclosed mono-component high loft spun-bond web 2, as described herein, which has been formed into rows of spaced pleats 4. The spaced pleats 4 are oppositely-facing pleats and are self-supporting. The pleated filter 1 can comprise the nonwoven web produced by bonding the collected mass 20 described herein. The high loft nonwoven web that is described herein can have increased stiffness compared to other high loft nonwoven webs. The increased stiffness can provide ample stiffness for forming a self-supporting pleated filter 1. In certain embodiments, the high loft nonwoven web that is used as the filter material for the pleated filter comprises a biodegradable material, particulate material, a frame material, or a combination thereof.

Persons having ordinary skill in the art will appreciate that filter 1 may be used as is or that selected portions of filter 1 may be stabilized or reinforced (e.g., with a planar expanded metal face layer, reinforcing lines of hot-melt adhesive, adhesively-bonded reinforcing bars or other selective reinforcing support) and optionally mounted in a suitable frame (e.g., a metal or cardboard frame) to provide a replaceable filter for use in e.g., heating, ventilation and air-conditioning (HVAC) systems.

Pleated web 2 forms a porous monolayer matrix which taken by itself has enhanced stiffness that assists in forming the pleats 4, and after pleating assists the pleats 4 in resisting deformation at high filter face velocities. Aside from the mono-component high loft spun-bond web 2, further details regarding the construction of filter 1 will be familiar to those skilled in the art. For example, such pleated filters are discussed in further detail in U.S. Pat. No. 7,947,142 to Fox, et al., which is incorporated by reference herein for this purpose.

FIG. 6 shows a pleated filter 114 containing filter media comprised of high loft spun-bond web 20 as described herein, and further comprising perimeter frame 112 and scrim 110. Although shown in FIG. 6 as a planar construction in discontinuous contact with one face of the filter media, scrim 110 may be pleated along with the filter media (e.g., so as to be in substantially continuous contact with the filter media). Scrim 110 can include a variety of stiffeners and/or supporting materials. Scrim 110 may be comprised of nonwoven material, wire, fiberglass, pleat backing, among a variety of other supporting materials.

Possibly due to their high loft and high ratio of Effective Fiber Diameter to Actual Fiber Diameter allowing them to function as depth filters, webs as described herein can exhibit advantageous filtration properties, for example high filtration efficiency in combination with low pressure drop. Such properties may be characterized by any of the well known parameters including percent penetration, pressure drop, Quality Factor, capture efficiency (e.g., Minimum Composite Efficiency, Minimum Efficiency Reporting Value), and the like. In particular embodiments, webs as disclosed herein comprise a Quality Factor of at least about 0.5, at least about 0.7, or at least about 1.0.

Nonwoven fibrous webs of the present disclosure and filter media including the same may, in some embodiments, advantageously incorporate a biodegradable material, a particulate material, a frame material, or a combination thereof. Some filter media incorporating biodegradable material (e.g. polyhydroxy alkonates (PHA), polyhydroxybutyrates (PHB), and the like) may, at the end of their useful life, be disposed of advantageously in municipal land-fills or industrial composting sites, thereby eliminating the need to return or otherwise recycle the spent filter media.

The operation of various embodiments of the present disclosure will be further described with regard to the following detailed Examples.

### EXAMPLES

The following Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, and the like in the Examples and the rest of the specification are provided on the basis of weight. Solvents and other reagents used may be obtained from Sigma-Aldrich Chemical Company (Milwaukee, Wis.) unless otherwise noted.

### Test Methods:

### Filament Diameter

The actual diameter of the filaments was measured optically using a microscope equipped with a camera, capable of at least 200× magnification, a 10 Megapixel microscope camera and software equivalent to Olympus D.E. Light Version 5.0 or later available from Olympus Americas INC, 3500 Corporate Parkway, PO Box 610 Center Valley, Pa. Optical photomicrographs were taken of the filaments. The scale of the photomicrographs was calibrated against a standard reference. Diameters were measured by determining segment lengths equal to the width of in-focus filaments in the micrographs. A total of at least 30 diameter measurements were analyzed for the reported diameters; the median filament diameter is reported.

### Effective Filament Diameter (EFD)

The Effective Filament Diameter (EFD) of the filaments in the Examples were measured according to the method set forth in Davies, C. N., “The Separation of Airborne Dust and Particles,” Institution of Mechanical Engineers, London, Proceedings 1B, 1952. Unless otherwise noted, the test is run at a face velocity of 14 cm/sec.

### Solidity and Loft

Solidity is determined by dividing the measured hulk density of the nonwoven fibrous web by the density of the materials making up the solid portion of the web. Bulk density of a web can be determined by first measuring the weight (e.g. of a 10-cm-by-10-cm section) of a web. Dividing, the measured weight of the web by the web area provides the basis weight of the web, which is reported in g/m². The thickness of the web can be measured by obtaining (e.g., by die cutting) a 135 mm diameter disk of the web and measuring the web thickness with a 230 g weight of 100 mm diameter centered atop the web. The bulk density of the web is determined by dividing the basis weight of the web by the thickness of the web and is reported as g/m³.

The solidity is then determined by dividing the bulk density of the nonwoven fibrous web by the density of the material (e.g. polymer) comprising the solid filaments of the web. The density of a bulk polymer can be measured by standard means if the supplier does not specify the material density. Solidity is a dimensionless fraction which is usually reported in percentage.

Loft is usually reported as 100% minus the solidity (e.g., a solidity of 7% equates to a loft of 93%).

### Percent (%) Penetration, Pressure Drop, and Quality Factor

Percent penetration, pressure drop and the filtration Quality Factor (QF) of the nonwoven fibrous webs were determined using a challenge aerosol containing, DOP (dioctyl phthalate) liquid droplets, delivered (unless otherwise indicated) at a flow rate of 85 liters/min to provide a face velocity of 14 cm/s, and evaluated using a TSI (Registered Trademark) Model 8130 high-speed automated filter tester (commercially available from TSI Inc., Shoreview, Minn.). For DOP testing, the aerosol may contain particles with a diameter of about 0.185 μm, and the Automated Filter Tester may be operated with the heater off and the particle neutralizer on. Calibrated photometers may be employed at the filter inlet and outlet to measure the particle concentration and the is particle penetration through the filter. An MKS pressure transducer (commercially available from MKS Instruments, Wilmington, Mass.) may be employed to measure pressure drop (DELTA P, mm H2O) through the filter. The equation:

$$QF = \frac{- ln ( \frac{\% Particle Penetration}{100} )}{Δ P}$$

may be used to calculate QF. The initial Quality Factor QF value usually provides a reliable indicator of overall performance, with higher initial QF values indicating better filtration performance and lower initial QF values indicating reduced filtration performance. Units of QF are inverse pressure drop (reported in 1/mm or mm⁻¹ H20).

### Capture Efficiency

The filtration properties of the filters were measured by testing in a similar manner to that described in ASHRAE Standard 52.2 (“Method of Testing General Ventilation Air-Cleaning Devices for Removal Efficiency by Particle Size”). The test involves configuring the web as a filler (e.g., a pleated and/or framed filter) installing the filter into a test duct and subjecting the filter to potassium chloride particles which have been dried and charge-neutralized. A test face velocity of 1.5 meters/sec may be employed. An optical particle counter was used to measure the concentration of particles upstream and downstream from the test filter over a series of twelve particle size ranges or channels. The equation:

$$Capture efficiency ( \% ) = \frac{upstream particle count - downstream particle count}{upstream particle count} \times 100$$

may be used to determine capture efficiency for each channel. After the initial efficiency measurement, a sequential series of dust loadings and efficiency measurements are made until the filter pressure reached a predetermined value; the minimum efficiency for each of the particle size channels during the test is determined, and the composite minimum efficiency curve is determined. Pressure drop across the filter is measured initially and after each dust loading, and both the amount of dust fed and the weight gain of the filter are determined. From the composite minimum efficiency curve, the four efficiency values between 0.3 and 1.0 μm may be averaged to provide the E1 Minimum Composite Efficiency (MCE), the four efficiency values between 1.0 and 3.0 μm may be averaged to provide the E2 MCE, and the four efficiency values between 3.0 and 10.0 μm may be averaged to provide the E3 MCE. From the MCE values for a filter, a reference table in the standard may be used to determine the Minimum Efficiency Reporting Value (MERV) for the filter.

### Tensile Strength

The tensile strength of the nonwoven fibrous webs was measured using a conventional Instron tensile testing machine (Instron Instruments, Norwood, Mass.) operated at a crosshead speed of 254 mm/min. 25 mm width test specimens were used with a gauge length of 51 mm. Test specimens were cut from the nonwoven webs in both the machine direction (MD) and cross direction (CD) and the specimens were strained to the point of maximum stress. The maximum load (stress) of the specimens was reported in Newtons (N) and was based on an average of at least 6 replicates per web sample.

The weight normalized tensile strength was also calculated by dividing the tensile strength by the area (basis) weight of the nonwoven webs and multiplying by 100, and was reported in Newtons per 100 grams/square meter (N/100 gsm).

### Fiber Spinning Speed

The apparent filament spinning speed was calculated by performing a mass balance on the filaments of the web and taking into account the rate at which polymer was fed to the extrusion orifices. The spinning speed was calculated using the equation below, where the extrusion flowrate (\dot{m}) is in grams per orifice per minute, density (ρ) is in grams per cubic centimeter, and filament diameter (φ) is in microns:

$$v ( m \text{/} min ) = 1 , 273 , 240 \frac{\dot{m}}{{ρφ}^{2}}$$

### Examples 1-4

A mono-component monolayer nonwoven web was produced from polylactic acid (PLA, obtained from NatureWorks LLC, 15305 Minnetonka Boulevard, Minnetonka, Minn., under the trade designation 6202D) using an apparatus similar to that shown in FIGS. 1 and 2. The extrusion head had orifices of 0.35 mm diameter with a 4:1 L/D (length to diameter) ratio which were configured in a pattern having a linear density of approximately 900 orifices per meter. The orifices were spaced forming adjoining isosceles triangles with a base aligned 90 degrees to the direction of travel of the collector belt of 14 mm and a height of 9.5 mm, the holes being at the vertices. There were 13 rows of holes. The flowrate of molten PLA polymer was approximately 1.99 grams per orifice per minute, with an extrusion temperature of 230° C.

Two opposed quenching air streams (similar to those shown as 18b in FIG. 1) were supplied from quench boxes 41 cm in height with an approximate face velocity of 0.8 m/sec and a temperature slightly chilled from ambient. A movable-wall attenuator similar to that shown in U.S. Pat. Nos. 6,607,624 and 6,916,752 was employed, using an air knife gap of 0.51 mm, air fed to the air knife at a pressure of 117 kPa, an attenuator top gap width of 7.1 mm, an attenuator bottom gap width of 7.1 mm, and an attenuation chamber length of 15 cm. The distance from the extrusion head to the attenuator was approximately 61 cm, and the distance from the bottom of the attenuator to the collection belt was approximately 66 cm. The melt-spun filament stream was deposited on the collection belt at a width of about 53 cm with a vacuum established under the collection belt of approximately 650 Pa. The collection belt was a 9 SS TC model from Albany International Corp. (Rochester, N.H.) and moved at a velocity (“forming speed”) shown in Table 1.

The mass (web) of collected melt-spun nonwoven filaments was then passed underneath a controlled-heating bonding device to autogeneously bond some of the filaments together. Air was supplied through the bonding device which had an outlet slot 7.6 cm by 71 cm. The air outlet was about 2.5 cm from the collected web as the web passed underneath the bonding device. The temperature and velocity of the air passing through the slot of the controlled heating device are shown in Table 1. The temperature was measured at the entry point for the heated air into the housing of the bonding device. Ambient temperature air was forcibly drawn through the web after the web passed underneath the bonding device, to cool the web to approximately ambient temperature.

The resulting nonwoven web was bonded with sufficient integrity to be self-supporting and handleable using standard processes and equipment, such as wound into a storage roll or subjected to various operations such as pleating and assembly into a filtration device such as a pleated filter panel. Webs were collected at several different area (basis) weights produced by varying the speed of the collection belt. Several different bonding conditions were used. The webs of Examples 3 and 4, contained 1.5% TiO₂ white pigment (obtained from Clariant, 4000 Monroe Road, Charlotte, N.C., identified as color number OM03642459) which was added to the extruder as a pre-compounded concentrate using the same PLA as the base PLA used in the extruded filaments. Several variations of the web were produced, as described in Table 1.

TABLE 1

| Property | Units | Example 1 | Example 2 | Example 3 | Example 4 |
|---|---|---|---|---|---|
| Forming Speed | m/s | 0.49 | 0.50 | 0.54 | 0.74 |
| Bonding Temperature | ° C. | 140 | 150 | 140 | 140 |
| Bonding Air Velocity | m/s | 5.9 | 6.9 | 5.9 | 5.9 |
| Basis Weight | g/m² | 55 | 56 | 54 | 38 |
| Pressure Drop @ 14 cm/s | mm H2O | 0.26 | 0.24 | 0.25 | 0.16 |
| Median Filament Diameter | μm | 22 | 21 | 20 | 20 |
| Web Thickness | mm | 0.64 | 0.69 | 0.59 | 0.46 |
| Web Solidity | % | 6.9% | 6.6% | 7.4% | 6.7% |
| Effective Filament Diameter (EFD) | μm | 28 | 29 | 28 | 29 |
| % Penetration DOP @ 14 cm/s | % | | | 80 | 87 |
| Quality Factor | min⁻¹ H₂O | | | 0.89 | 0.87 |
| MD Tensile | N | 9.2 | 24.2 | 12.8 | 9.3 |
| CD Tensile | N | 6.3 | 22.3 | 6.5 | 3.7 |
| CD Tensile/BW × 100 | — | 12 | 40 | 12 | 10 |
| Filament Spinning Speed | m/min | 4356 | 4628 | 5161 | 5447 |

The webs of Examples 3 and 4 were corona charged at approximately −19 kV using methods well known in the art. Basis weight, Pressure Drop at 14 cm/s, Effective and Actual Fiber Diameter, Thickness, Solidity, % Penetration of DOP, Quality Factor, MD and CD tensile strength, and calculated Filament Spinning Speed were measured and are listed in Table 1A. The samples exhibited less than 8% solidity, greater than 3000 m/min spinning speed, and a specific CD tensile strength (normalized by basis weight) of 10 Newtons per 100 grams/square meter or higher.

The charged samples for the webs of Examples 3 and 4 and the uncharged example webs 1 and 2 were laminated to a wire mesh reinforcement using a hot melt adhesive. The laminates were pleated with a rotary star-wheel style pleater (obtained from Filtration Technology Systems (FTS), New Albany, Ind.), which was operated to provide approximately 30 mm pleat spacing and a pleat length of approximately 50 mm. The pleated laminates were framed into filters with a perimeter pinch-style frame to provide a final filter dimension of approximately 40×63×2 cm. The filters were evaluated according to ASHRAE Standard 52.2 to a final pressure of 125 Pa at a face velocity of 1.5 m/s. The Initial Pressure Drop, Minimum Composite Efficiency, Minimum Efficiency Report Value (MERV), Arrestance, and Dust Holding Capacity were obtained for each charged pleated filter and are listed in Table 2.

TABLE 2

| Property | Units | Example 1 | Example 2 | Example 3 | Example 4 |
|---|---|---|---|---|---|
| Pressure Drop | Pa | 31 | 33 | 34 | 23 |
| (initial) | | | | | |
| E1 MCE | % | | | 13 | 10 |
| (0.3-1.0 μm) | | | | | |
| E2 MCE | % | | | 35 | 28 |
| (1-3 μm) | | | | | |
| E3 MCE | % | | | 33 | 30 |
| (3-10 μm) | | | | | |
| MERV | | | | 5 | 5 |
| Arrestance | % | 76% | 77% | 77% | 79% |
| Dust Holding | grams | 13.1 | 8.5 | 11.5 | 14.0 |
| Capacity | | | | | |

The uncharged filters were only tested for Initial Pressure Drop, Arrestance, and Dust Holding Capacity. The uncharged filters exhibited a particularly low initial pressure drop, being notably less than 50 Pa.

### Examples 5-6

A second set of web samples were prepared as in Example 1 with the following exceptions. The polymer used to produce the nonwoven was polypropylene (obtained from Total Petrochemicals, Total Plaza, 1201 Louisiana Street, Suite 1800 Houston, Tex., under the trade designation 3860X). The extruder was run at a rate to produce 1.48 grams of polymer per orifice per minute, with an extrusion temperature of 215° C. The web was deposited at a width of approximately 56 cm. The quench air velocity was approximately 1.0 m/s. The attenuator was run with a top wall gap of 6.1 mm, a bottom gap of 5.3 mm, and an air pressure of 55 kPa. The bonding apparatus had a slot width of 76 cm and was operated at an air temperature of 145° C. with a velocity of 6.1 m/s. The webs were collected at several different area (basis) weights produced by varying the speed of the collection belt. Several variations of the web were produced, as described in Table 3.

TABLE 3

| Property | Units | Example 5 | Example 6 |
|---|---|---|---|
| Forming Speed | m/s | 0.46 | 0.28 |
| Basis Weight | g/m² | 39 | 70 |
| Pressure Drop @ 14 cm/s | mm H2O | 0.23 | 0.45 |
| Median Filament Diameter | μm | 22 | 22 |
| Web Thickness | mm | 0.62 | 1.05 |
| Web Solidity | % | 7.0% | 7.2% |
| Effective Filament Diameter (EFD) | μm | 29 | 28 |
| % Penetration DOP @ 14 cm/s | % | 82 | 78 |
| Quality Factor | mm⁻¹ H₂O | 0.85 | 0.56 |
| MD Tensile | N | 11.6 | 19.6 |
| CD Tensile | N | 10.5 | 27.0 |
| CD Tensile/BW × 100 | — | 27 | 39 |
| Filament Spinning Speed | m/min | 4331 | 4007 |

Example webs 5 and 6 were corona charged at approximately −19 kV using methods well known in the art. Basis weight, Pressure Drop at 14 cm/s, Effective and Actual Filament Diameter, Thickness, Solidity, % Penetration of DOP, Quality Factor, MD and CD tensile strength, and calculated Filament Spinning Speed were measured and are listed in Table 3. The samples exhibited less than 8% solidity, greater than 3000 m/min spinning speed, and a specific CD tensile strength (normalized by basis weight) of greater than 10 Newtons per 100 grams/square meter.

The charged samples for the webs of Examples 5 and 6 were laminated to a wire mesh reinforcement using a hot melt adhesive. The laminates were pleated with a rotary star-wheel style pleater, (obtained from Filtration Technology Systems (FTS), New Albany, Ind.), which was operated to provide a pleat length of approximately 50 mm. The pleat spacing was varied and is reported in Table 2B. The pleated laminates were framed into filters with a perimeter pinch-style frame to provide a final filter dimension of approximately 40×63×2 cm. The filters were evaluated according to ASHRAE Standard 52.2 to a final pressure of 125 Pa at a face velocity of 1.5 m/s. The Initial Pressure Drop, Minimum Composite Efficiency, Minimum Efficiency Report Value (MERV), Arrestance, and Dust Holding Capacity were obtained for each charged pleated filter and are listed in Table 4. The filters exhibited an initial pressure drop of less than 50 Pa.

TABLE 4

| Property | Units | Example 5 | Example 6 |
|---|---|---|---|
| Pleat Spacing | mm | 30 | 25 |
| Pressure Drop (initial) | Pa | 30 | 44 |
| E1 (0.3-1.0 μm) | % | 9 | 14 |
| E2 (1-3 μm) | % | 25 | 42 |
| E3 (3-10 μm) | % | 20 | 36 |
| Arrestance | % | 75% | 84% |
| Dust holding Capacity | grams | 10.6 | 9.7 |

### Example 7

Mono-component monolayer nonwoven webs were produced as in Example 1. The polymer used to produce the nonwoven was polypropylene (obtained from Total Petrochemicals, Total Plaza, 1201 Louisiana Street, Suite 1800 Houston, Tex., under the trade designation 3860X). The extrusion head had orifices of 0.35 mm diameter with a 4:1 L/D ratio which were configured in a row and column pattern at a linear density of approximately 1800 orifices per meter. 26 rows of orifices were included, with orifices center-to-center spaced 4.2 mm in the machine direction and 14 mm in the cross-direction. The flow rate of molten polymer was approximately 1.08 grams per orifice per minute, with an extrusion temperature of 215° C.

Two opposed quenching air streams (similar to those shown as 18b in FIG. 1) were supplied from upper quench boxes 34 cm in height at an approximate face velocity of 1.1 m/sec and a temperature slightly chilled from ambient. Two additional opposed quenching air streams were supplied from lower quench boxes 34 cm in height at an approximate face velocity of 0.9 m/sec and at ambient temperature. A movable-wall attenuator similar to that shown in FIG. 1 of U.S. Pat. No. 6,660,218 was employed, using an air knife gap of 0.64 mm, air knife air at a pressure of 138 kPa, an attenuator top gap width of 6.4 mm, an attenuator bottom gap width of 5.8 mm, and an attenuation chamber length of 30 cm (distance 8 in FIG. 1 from U.S. Pat. No. 6,660,218).

The distance from the extrusion head to the attenuator was approximately 89 cm, and the distance from the bottom of the attenuator to the collection belt was approximately 58 cm. The melt-spun filament stream was deposited onto the collection belt at a width of about 61 cm with a vacuum established under the collection belt of approximately 800 Pa. The collection belt was a V-Tex-V-U model obtained from Voith Paper Holding GmbH & Co. KG (Heidenheim, Germany). The belt moved at a velocity (“forming speed”) of 0.61 m/s.

The mass of collected melt-spun filaments (web) was then passed underneath a controlled-heating bonding device to autogeneously bond some of the filaments together. Air was supplied through the bonding device which had an outlet slot, which was 15 cm by 76 cm. The air outlet was about 2.5 cm from the collected web as the web passed underneath the bonding device. The temperature of the air passing through the controlled heating device was 148° C., and the air velocity at the slot exit was 3.2 m/s. The temperature was measured at the entry point for the heated air into the housing. Ambient temperature air was forcibly drawn through the web after the web passed underneath the bonding device, to cool the web to approximately ambient temperature.

The resulting nonwoven web was bonded with sufficient integrity to be self-supporting and handleable using standard processes and equipment, such as wound into a storage roll or subjected to various operations such as pleating and assembly into a filtration device such as a pleated filter panel.

Basis weight, Pressure Drop at 14 cm/s, Effective and Actual Filament Diameter, Thickness, Solidity, both MD and CD tensile strength, and calculated Filament Spinning Speed were then obtained for these webs, and are listed in Table 5. The nonwoven web exhibited less than 8% solidity, greater than 3000 m/min spinning speed, and a specific CD tensile (normalized by basis weight) of greater than 10 Newtons per 100 grams/square meter.

TABLE 5

| Property | Units | Example: 7 |
|---|---|---|
| Forming Speed | m/s | 0.61 |
| Basis Weight | g/m² | 41 |
| Pressure Drop @ 14 cm/s | mm H2O | 0.29 |
| Median Filament Diameter | μm | 19 |
| Web Thickness | mm | 0.60 |
| Web Solidity | % | 7.5% |
| Effective Filament Diameter (EFD) | μm | 27 |
| MD Tensile | N | 17.0 |
| CD Tensile | N | 10.3 |
| CD Tensile/BW × 100 | — | 25 |
| Filament Spinning Speed | m/min | 4174 |

The web of Example 7 was then laminated to a wire mesh reinforcement using a hot melt adhesive. The laminates were pleated with a rotary star-wheel style pleater, (obtained from Filtration Technology Systems (FTS), New Albany, Ind.), which was operated to provide a pleat length of approximately 50 mm and a pleat spacing of approximately 30 mm. The pleated laminate was then framed into a filter with a perimeter pinch-style frame to provide a final filter dimension of approximately 40×63×2 cm. The filter was evaluated according to ASHRAE Standard 52.2 to a final pressure of 125 Pa at a face velocity of 1.5 m/s. The Initial Pressure Drop, Minimum Composite Efficiency, Minimum Efficiency Report Value (MERV), Arrestance, and Dust Holding Capacity were obtained for the pleated filter and are listed in Table 6. The filter exhibited an initial pressure drop of less than 50 Pa.

TABLE 6

| Property | Units | Example: 7 |
|---|---|---|
| Pressure Drop (initial) | Pa | 40 |
| E1 (0.3-1.0 μm) | % | 6 |
| E2 (1-3 μm) | % | 21 |
| E3 (3-10 μm) | % | 13 |
| Arrestance | % | 68% |
| Dust Holding Capacity | grams | 7.1 |

### Examples 8-9

Mono-component monolayer nonwoven webs were produced as in Example 1. The extrusion head had orifices of 0.35 mm diameter with a 4:1 L/D ratio which were configured in a row and column pattern at a linear density of approximately 1800 orifices per meter. 26 rows of orifices were included, with orifices center-to-center spaced 4.2 mm in the machine direction and 14 mm in the cross-direction. The flow rate of molten polymer was approximately 1.38 grams per orifice per minute, with an extrusion temperature of 230° C. Two opposed quenching air streams (similar to those shown as 18b in FIG. 1) were supplied from upper quench boxes 34 cm in height at an approximate face velocity of 1.1 m/sec and a temperature slightly chilled from ambient. Two additional opposed quenching air streams were supplied from lower quench boxes 34 cm in height at an approximate face velocity of 0.5 m/sec and at ambient temperature.

A movable-wall attenuator similar to that shown in U.S. Pat. No. 6,660,218 was employed, using an air knife gap of 0.64 mm, air knife air at a pressure of 207 kPa, an attenuator top gap width of 6.1 mm, an attenuator bottom gap width of 5.3 mm, and an attenuation chamber length of 30 cm (distance 8 in FIG. 1 from U.S. Pat. No. 6,660,218). The distance from the extrusion head to the attenuator was approximately 74 cm, and the distance from the bottom of the attenuator to the collection belt was approximately 74 cm. The melt-spun filament stream was deposited on the collection belt at a width of about 61 cm with a vacuum established under the collection belt of approximately 650 Pa. The collection belt was the same as in Example 3 and moved at a velocity (“forming speed”) shown in Table 7 below. Two webs were produced each at a different forming speed.

The nonwoven webs were then passed underneath a controlled-heating bonding device to autogeneously bond some of the filaments together. Air was supplied through the bonding device which had an outlet slot, which was 15 cm by 76 cm. The air outlet was about 2.5 cm from the collected web as the web passed underneath the bonding device. The temperature of the air passing through the controlled heating device was 140° C., and the air velocity at the slot exit was 3.2 m/s. The temperature was measured at the entry point for the heated air into the housing. Ambient temperature air was forcibly drawn through the web after the web passed underneath the bonding device, to cool the web to approximately ambient temperature.

The resulting nonwoven webs were bonded with sufficient integrity to be self-supporting and handleable using standard processes and equipment, such as wound into a storage roll or subjected to various operations such as pleating and assembly into a filtration device such as a pleated filter panel.

Basis weight, Pressure Drop at 14 cm/s, Effective and Actual Filament Diameter, Thickness, Solidity, MD and CD tensile strength, and calculated Filament Spinning Speed were then measured for these webs, and are listed in Table 7. The webs exhibited less than 8% solidity, greater than 3000 m/min spinning speed, and a specific CD tensile (normalized by basis weight) of greater than 10 Newtons per 100 grams/square meter.

TABLE 7

| | | Example: | |
|---|---|---|---|
| Property | Units | 8 | 9 |
| Forming Speed | m/s | 0.76 | 0.55 |
| Basis Weight | g/m² | 39 | 50 |
| Pressure Drop @ 14 cm/s | mm H2O | 0.17 | 0.26 |
| Median Filament Diameter | μm | 18 | 18 |
| Web Thickness | mm | 0.50 | 0.52 |
| Web Solidity | % | 6.3% | 7.8% |
| Effective Filament Diameter (EFD) | μm | 28 | 27 |
| MD Tensile | N | 10.3 | 14.5 |
| CD Tensile | N | 4.8 | 7.6 |
| CD Tensile/BW × 100 | — | 12 | 15 |
| Filament Spinning Speed | m/min | 4392 | 4180 |

The webs of Examples 8 and 9 were then laminated to a wire mesh reinforcement using a hot melt adhesive. The laminates were pleated with a rotary star-wheel style pleater, (obtained from Filtration Technology Systems (FTS), New Albany, Ind.), which was operated to provide a pleat length of approximately 50 mm and a pleat spacing of approximately 30 mm. The pleated laminate was then framed into a filter with a perimeter pinch-style frame to provide a final filter dimension of approximately 40×63×2 cm. The filter was evaluated according to ASHRAE Standard 52.2 to a final pressure of 125 Pa at a face velocity of 1.5 m/s. The Initial Pressure Drop, Minimum Composite Efficiency, Minimum Efficiency Report Value (MERV), Arrestance, and Dust Holding Capacity were obtained for the pleated filter and are listed in Table 8. The filter exhibited an initial pressure drop of less than 50 Pa.

TABLE 8

| | | | |
|---|---|---|---|
| Property | Units | Example 8 | Example 9 |

| | | | |
|---|---|---|---|
| Pressure Drop (initial) | Pa | 25 | 34 |
| E1 (0.3-1.0 μm) | % | 6 | 8 |
| E2 (1-3 μm) | % | 20 | 27 |
| E3 (3-10 μm) | % | 16 | 20 |
| Arrestance | % | 64% | 75% |
| Dust Holding Capacity | grams | 13.0 | 11.6 |

### Example 10

The nonwoven web of Example 6 was evaluated for its ability to form a self-supporting pleat structure (identified as Example 10). The web was electrostatically charged as in Example 1 prior to the pleating process. Triangular-shaped pleats were formed with a pleat height of approximately 23 mm on a folding-style blade pleater; pleats were heat stabilized at a temperature of approximately 65° C. The pleats were framed in a one-piece die-cut box frame, which supported the pleats on the downstream pleat tips only, to provide a final filter dimension of approximately 40×63×2 cm. Filters were assembled with a pleat spacing of 23 mm. The pleated web retained its pleated shape through normal use and testing when formed into a self-supporting pleat structure.

The filters were evaluated according to ASHRAE Standard 52.2 to a final pressure of 125 Pa at a face velocity of 1.5 m/s. Initial Pressure Drop, Initial Efficiency, Arrestance, and Dust Holding Capacity were obtained for each charged pleated filter and are listed Table 9. The filters had an initial pressure drop of less than 50 Pa. The self-supporting pleated filters had a lower pressure drop and higher dust holding capacity than the same web when formed into a wire-backed filter.

TABLE 9

| | | Example |
|---|---|---|
| Property | Units | 10 |
| Pressure Drop (initial) | Pa | 41 |
| E1 (0.3-1.0 μm) | % | 14 |
| E2 (1-3 μm) | % | 43 |
| E3 (3-10 μm) | % | 44 |
| Arrestance | % | 86% |
| Dust Holding Capacity | grams | 12.6 |

It is further contemplated that patterned melt-spun or spun-bond nonwoven fibrous webs, more particularly patterned electret melt-spun or spun-bond nonwoven fibrous webs, may be advantageously prepared by combining the methods of the present disclosure with those described in U.S. Patent Publication No. 2013/0108831, published May 2, 2013, and titled “Patterned Air-laid Nonwoven Electret Fibrous Webs, and Methods of Making and Using Same,” the entire disclosure of which is incorporated herein by reference in its entirety.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the presently described invention. Thus, the appearances of the phrases such as “in one or more embodiments,” “in certain embodiments,” “in one embodiment” or “in an embodiment” in various places throughout this specification are not necessarily referring to the same embodiment of the presently described invention. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A nonwoven web comprising:
a population of substantially continuous mono-component melt-spun filaments, wherein the nonwoven web exhibits a Solidity of less than eight percent with a weight normalized cross direction (CD) tensile greater than 10 Newtons per 100 grams per square meter of web weight (10 N/100 gsm), and wherein the nonwoven web is substantially free of gap-formed fibers, crimped fibers, staple fibers, and bi-component fibers.

2. The nonwoven web of claim 1, wherein the population of melt-spun filaments exhibits a Median Fiber Diameter of from 15 to 45 micrometers.

3. The nonwoven web of claim 1, wherein the population of melt-spun filaments is bonded together at a plurality of intersections between one or more of the filaments.

4. The nonwoven web of claim 1, wherein the population of melt-spun filaments comprises a (co)polymer selected from one of polypropylene, polyethylene, polybutene, polyethylene terephthalate, polybutylene terephthalate, polytrimethylene terephthalate, polyethylene napthalate, polyamide, polyurethane, polylactic acid, polyvinyl alcohol, polyphenylene sulfide, polysulfone, liquid crystalline polymer, polyethylene-co-vinylacetate, polyacrylonitrile, cyclic polyolefin, polyoxymethylene, or polyolefinic thermoplastic elastomers.

5. The nonwoven web of claim 1, wherein the population of melt-spun filaments forms a first layer of the nonwoven web, and a second layer of the nonwoven web comprises staple fibers, air-laid fibers, melt-blown fibers, melt-spun filaments, electrospun fibers, wet-laid fibers, or a combination thereof.

6. The nonwoven web of claim 5, wherein the second layer comprises melt-spun filaments that differ from the population of melt-spun filaments comprising the first layer.

7. The nonwoven web of claim 5, wherein the second layer exhibits a Solidity greater than eight percent.

8. The nonwoven web of claim 1, exhibiting a basis weight of from about 30 to about 120 grams per square meter (gsm).

9. The nonwoven web of claim 1, exhibiting a thickness of at least about 0.4 millimeters (mm).

10. A filter comprising the nonwoven web of claim 1.

11. The filter of claim 10, having a plurality of oppositely-facing pleats.

12. The filter of claim 11, wherein the plurality of pleats is self-supporting.

13. The pleated filter of claim 11, wherein the plurality of pleats is not self-supporting, and further wherein the filter further comprises a mesh to support the pleats.

14. The filter of claim 10, wherein the filter further comprises a biodegradable material, a particulate material, a frame material, or a combination thereof.

15. A method of making a nonwoven web, comprising:
(a) forming a plurality of substantially continuous melt-spun filaments with a melt-spinning process, wherein the melt-spinning process comprises a filament spinning speed of at least 3,000 meters per minute (m/min) and optionally, a filament extrusion rate of at least 0.8 grams per orifice per minute (gom);
(b) collecting a population of the melt-spun filaments on a collector surface; and
(c) bonding at least a portion of the melt-spun filaments together at a plurality of intersections between one or more of the filaments, optionally wherein the bonding comprises autogeneous bonding.

16. The method of claim 15, wherein the plurality of melt-spun filaments are mono-component filaments, further wherein the population of melt-spun filaments exhibits a Median Fiber Diameter of from 15 to 45 micrometers and the nonwoven web exhibits a Solidity of less than eight percent with a weight-normalized cross direction (CD) tensile greater than 10 Newtons per 100 grams per square meter of web weight (10 N/100 gsm), and additionally wherein the nonwoven web is substantially free of gap-formed fibers, crimped fibers, staple fibers, and bi-component fibers.

17. The method of claim 15, wherein (a)-(c) are performed to produce a first layer of the nonwoven web, and wherein (a)-(c) are repeated to form a second layer of the nonwoven web over the first layer.

18. The method of claim 15, further comprising electrostatically charging at least a portion of the melt-spun filaments.

19. The method of claim 15, wherein the filament spinning speed is no greater than 7,000 m/min.

20. The method of claim 15, wherein a quenched flow heater is used in (c) to bond the filaments.
